(19) United States
(12) Patent Application Publication
(10) Pub. No.: US 2005/0225012 A1
(43) Pub. Date: Oct. 13, 2005

(54) Method of producing abrasive tools

(76) Inventors: Alex Cooper, Brooklyn, NY (US); Sergey Vladimirtsev, Brooklyn, NY (US); Yevgeny Bederak, New York, NY (US)

Correspondence Address: IIya Zborovsky, 6 Schoolhouse Way, Dix Hills, NY, 11746, US

(21) Appl. No.: 10/822,878

(22) Filed: Apr. 13, 2004

(51) Int. Cl. C04B 33/32

(52) U.S. Cl. 264/603

(57) ABSTRACT

A method of producing abrasive tools with abrasive particles composed of aluminum oxide has the steps of producing a mixture of initial components with particles of Al(OH)₃, forming blanks of abrasive tools from the mixture, and subsequently subjecting the blanks to a heat treatment so that the particles of Al(OH)₃ are converted into abrasive particles of Al₂O₃.

### BACKGROUND OF THE INVENTION

The present invention relates to a method of producing abrasive tools and to an abrasive tool produced by the method.

More particularly, the present invention relates to a method of producing abrasive tools and to an abrasive tool produced by the method in which particles of abrasive are composed of aluminum oxide.

Methods of producing abrasive tools of this type are known in the art. In accordance with a known method, an initial material including several components, and aluminum oxide abrasive power is processed by rolling in rolls to obtain a sheet, and thereafter the corresponding tools are made from the sheet, for example by punching with subsequent thermal treatment. The disadvantage of this solution is that generally the rolls are formed of metal, and during rolling of the sheet, the hard particles of aluminum oxide cut the surfaces of the rolls and therefore significantly wear them.

### SUMMARY OF THE INVENTION

It is an object of the present invention to provide a new method of producing abrasive tools and to an abrasive tool produced by the method which eliminate the disadvantages of the prior art.

In keeping with these objects and with others which will become apparent hereinafter, one feature of the present invention resides, briefly stated in a method of producing abrasive tools with abrasive particles composed of aluminum oxide, comprising the steps of producing a mixture including particles composed of Al(OH)₃, forming blanks of abrasive tools from the mixture; and subsequently subjecting the blanks to a heat treatment so that the particles of Al(OH)₃ are converted into particles of Al₂O₃.

When the method is performed and an abrasive tool is made in accordance with the present invention, the particles which together with other components of an initial mixture are subjected to rolling in rolls are not aluminum oxide particles which are very hard but instead are particles of Al(OH)₃, so that the rolls are no longer subjected to excessive wear as in the prior art. During the subsequent thermal treatment Al(OH)₃ particles are converted into Al₂O₃ particles thus forming the final abrasive particles.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIGS. 1-3 are views showing corresponding steps of a new method for producing abrasive tools in accordance with the present invention.

### DESCRIPTION OF THE PREFERRED EMBODIMENTS

In accordance with the present invention abrasive tools with abrasive particles composed of aluminum oxide are produced in the following manner.

First of an initial material including mixture of several components is provided. The mixture can include for example a base of butadiene nytril rubber, a curing agent sulfur, a softener dibytilphtalate, polyvinyl chloride, hardener, phenolic resin, and a powder composed of particles of Al(OH)₃.

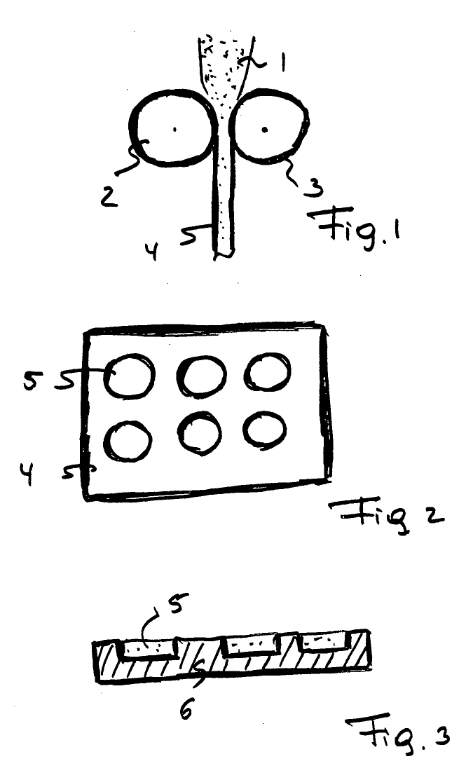

The thusly produced mixture which is identified with reference numeral 1 is rolled between rolls 2 and 3 so as to form a sheet 4 composed for example of the above-mentioned components and the particles of Al(OH)₃ as shown in FIG. 1.

After the sheet 4 is produced, it is supplied to a next working position shown in FIG. 2, in which blanks of abrasive tools or working elements of the abrasive tools are formed, as identified with reference numeral 5. If the abrasive tool is a self-supporting disk it is formed directly as shown in FIG. 2, for example by punching of the abrasive tool from the sheet 4. If the abrasive tool is a working element to be placed on a supporting base, spindle, etc., then the working element for the abrasive tool is produced as shown in FIG. 2.

The punched out blanks of working elements or tools, which can be disc-shaped or can have a different shape, are then supplied for a thermal treatment, for example in a mold 6 as shown in FIG. 3. In the mold 6, under the action of heat for example in an oven or a press, the working elements or the working tools 5 are sintered. During sintering at elevated temperature for example 200-300° C., the particles of Al(OH)₃ are converted into the particles of Al₂O₃, which form the final abrasive particles of the abrasive tool or of the working element of the abrasive tool.

It will be understood that each of the elements described above, or two or more together, may also find a useful application in other types of constructions differing from the types described above.

While the invention has been illustrated and described as embodied in a method of producing abrasive tools, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

1. A method of producing abrasive tools with abrasive particles composed of aluminum oxide, comprising the steps of producing a mixture of initial components with particles of Al(OH)₃; forming blanks of abrasive tools from the mixture; and subsequently subjecting the blanks to a heat treatment so that the particles of Al(OH)₃ are converted into abrasive particles of Al₂O₃.

2. A method of as defined in claim 1, wherein said forming includes making a sheet of the mixture of the initial components and the particles of Al(OH)₃, and thereafter separating the blanks of the abrasive tools from the sheet.

3. A method as defined in claim 2, wherein said making a sheet includes rolling the mixture of the components with the particles of Al(OH)₃ between rolls.

4. An abrasive tool, composed of blanks of abrasive tools from a mixture; of components with particles of Al(OH)₃, which are subsequently subjecting to a heat treatment so that the particles of Al(OH)₃ are converted into particles of Al₂O₃.
